(19) United States
(12) Patent Application Publication
(10) Pub. No.: US 2012/0293105 A1
(43) Pub. Date: Nov. 22, 2012

(54) ROTOR SLOT ASYMMETRY IN AN ELECTRIC MOTOR

(75) Inventors: Sinisa Jurkovic, Sterling Heights, MI (US); Khwaja M. Rahman, Troy, MI (US); Edward L. Kaiser, Orion, MI (US); Xinyu Zhou, Troy, MI (US); Qiang Niu, Novi, MI (US); Xu Han, Novi, MI (US)

(73) Assignee: GM GLOBAL TECHNOLOGY OPERATIONS LLC, Detroit, MI (US)

(21) Appl. No.: 13/112,020

(22) Filed: May 20, 2011

(51) Int. Cl. H02K 1/26; H02P 23/00

(52) U.S. Cl. 318/716; 310/216.072

(57) ABSTRACT

An electric motor includes a stator configured to receive electrical energy and generate an electromagnetic field in accordance with the electrical energy received. A rotor is in electromagnetic communication with the stator and is configured to rotate in accordance with the electromagnetic field generated by the stator. The rotor includes a plurality of poles including a first set of poles and a second set of poles. The first set of poles defines a first slot and the second set of poles defines a second slot that has a different configuration than the first slot to reduce a torque ripple effect. The electric motor may be used in a system having a power source configured to output direct current energy and an inverter configured to convert direct current energy to alternating current energy.

### TECHNICAL FIELD

The disclosure relates to an electric motor having asymmetrical rotor slots.

### BACKGROUND

Electric motors are used in various consumer products and industries. For instance, electric motors are used in hybrid vehicles to provide torque to propel the vehicle, charge a battery, start an internal combustion engine, etc. The electric motor may be powered by a battery or other energy storage device.

### SUMMARY

An example electric motor includes a stator and a rotor. The stator is configured to receive electrical energy and generate an electromagnetic field in accordance with the electrical energy received. The rotor is in electromagnetic communication with the stator and is configured to rotate in accordance with the electromagnetic field generated by the stator. The rotor includes a plurality of poles including a first set of poles and a second set of poles. The first set of poles defines a first slot and the second set of poles defines a second slot that has a different configuration than the first slot to reduce a torque ripple effect.

An example system includes a power source, an inverter, and an electric motor. The power source is configured to generate direct current energy. The inverter is in electrical communication with the power source and is configured to convert the direct current energy into alternating current energy. The electric motor has a stator in electrical communication with the inverter and a rotor in electrical communication with the power source and in electromagnetic communication with the stator. The stator is configured to receive the alternating current energy from the inverter and generate an electromagnetic field in accordance with the alternating current energy received. The rotor is configured to receive the direct current energy from the power source and rotate in accordance with the electromagnetic field generated by the stator. The rotor defines a first slot and a second slot that has a different configuration than the first slot to reduce a torque ripple effect.

An example rotor includes a core and a plurality of poles extending radially from the core. The plurality of poles includes a first set of poles defining a first slot and a second set of poles defining a second slot. The second slot has a different configuration than the first slot to reduce a torque ripple.

The above features and the advantages of the present disclosure are readily apparent from the following detailed description of the best modes for carrying out the invention when taken in connection with the accompanying drawings.

### BRIEF DESCRIPTION OF THE DRAWINGS

FIG. 1 is a schematic diagram of an example system that includes a synchronous motor with asymmetrical rotor slots.

FIG. 2 is a diagram of a portion of an example rotor with a plurality of poles that define asymmetrical slots.

FIG. 3 is a diagram of a portion of an example rotor with a plurality of poles that define slots with multiple asymmetric features.

FIG. 4 is a diagram of a portion of an example rotor with a plurality of poles that define the multiple asymmetrical slots of FIGS. 2 and 3.

### DETAILED DESCRIPTION

An electric motor includes a stator that can generate an electromagnetic field and a rotor that is configured to rotate in accordance with the electromagnetic field generated by the stator to generate a torque. The rotor includes a plurality of poles including a first set of poles and a second set of poles. The first set of poles defines a first slot and the second set of poles defines a second slot that is asymmetric relative to the first slot to reduce a torque ripple effect. That is, the first and second slots have different configurations relative to one another to reduce torque ripple.

Torque ripple may occur when the torque generated by the motor changes during the rotation of the rotor. Torque ripple may be caused by harmonics due to, e.g., physical properties of the rotor. The asymmetrical features of the first slot and the second slot, for instance, may reduce the torque ripple effect, and thus, allow the motor to output a more consistent torque during operation. The system described below may take many different forms and include multiple and/or alternate components and facilities than shown. While an example system is shown in the Figures, the components illustrated in the Figures are not intended to be limiting. Indeed, additional or alternative components and/or implementations may be used.

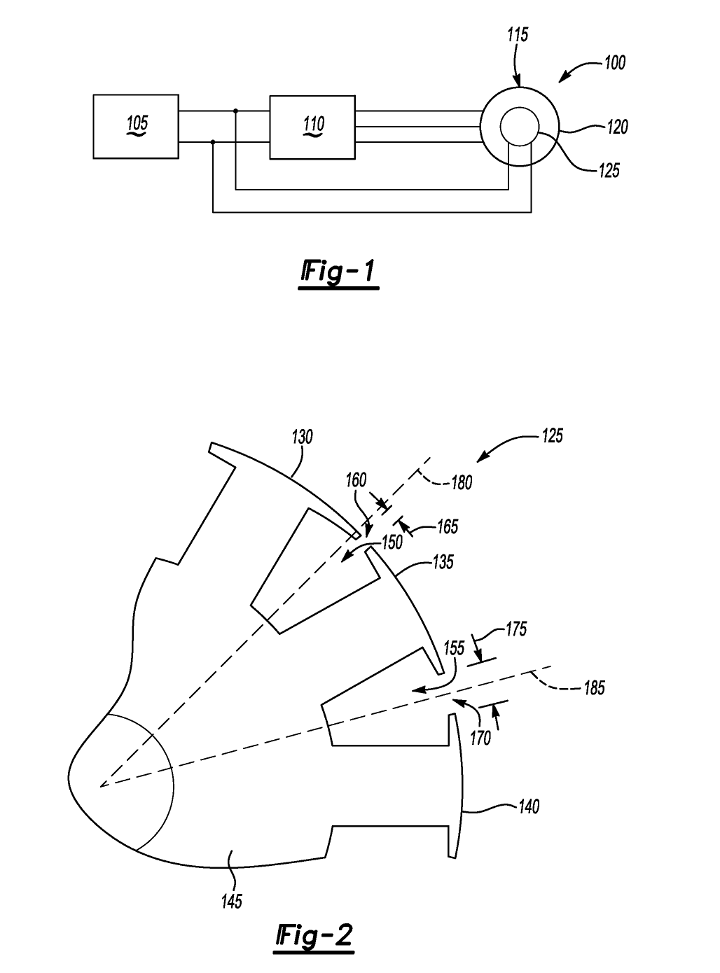

FIG. 1 illustrates an example system 100 that includes a power source 105, an inverter 110, and an electric motor 115. The system 100 may be implemented in any hybrid electric vehicle including a plug-in hybrid electric vehicle (PHEV) or an extended range electric vehicle (EREV), a battery electric vehicle (BEV), or the like. The system 100 may alternatively be implemented in non-automotive applications.

The power source 105 may include any device configured to generate electrical energy, such as direct current (DC) electrical energy. For example, the power source 105 may include a battery. That is, the power source 105 may include one or more electrochemical cells that are configured to convert stored chemical energy into electrical energy. In one possible approach, the power source 105 may be charged when provided with, e.g., DC energy.

The inverter 110 may include any device configured to convert DC energy into alternating current (AC) electrical energy. For instance, the inverter 110 may be in electrical communication with the power source 105 so that, e.g., the inverter 110 may convert the DC energy generated by the power source 105 into AC energy that may be output to other devices in the system 100. Accordingly, devices in the system 100 that are configured to receive AC energy may be powered by the power source 105. The inverter 110 may also include a rectifier configured to convert AC energy into DC energy. This way, AC energy generated by one or more other devices in the system 100 may be stored in the power source 105 as DC energy. In one possible implementation, the inverter 110 and rectifier may be separate devices in the system 100.

The electric motor 115 may include any device configured to convert electrical energy into rotational motion. For example, the motor 115 may be a synchronous machine configured to receive AC energy from the inverter 110 and generate rotational motion based on the electrical energy received. Moreover, the motor 115 may be configured to generate AC energy that, when converted into DC energy by the inverter 110 or rectifier, may be stored in the power source 105. As discussed in detail below with respect to FIG. 2, the rotor 125 may be configured to reduce torque ripple while rotating.

The electric motor 115 may include a stator 120 and a rotor 125. The stator 120 may be in electrical communication with the inverter 110 to, e.g., receive three-phase AC energy output by the inverter 110 and the stator 120 may be configured to generate an electromagnetic field in accordance with the AC energy received. In one example approach, the stator 120 may include an armature (not shown) that is configured to produce an electromagnetic field when provided with three-phase AC energy.

The rotor 125 may be in electrical communication with the power source 105 and in electromagnetic communication with the stator 120. In one possible approach, the rotor 125 may include field windings that receive DC energy output by the power source 105. The DC energy may magnetize portions of the rotor 125 so, e.g., the rotor 125 will rotate in accordance with the electromagnetic energy produced by the stator 120. The rotation of the rotor 125 allows the motor 115 to produce a torque. As discussed in detail below with respect to FIGS. 2-4, the rotor 125 defines asymmetrical slots (e.g., slots with different configurations) to reduce the torque ripple effect.

FIG. 2 illustrates a diagram of part of an example rotor 125 having a first pole 130, a second pole 135, and a third pole 140 that extend radially from a core 145. The first pole 130, the second pole 135, and the third pole 140 are at least partially spaced from one another to define, among others, a first slot 150 and a second slot 155 that are asymmetric relative to one another to reduce the torque ripple effect. That is, the first slot 150 and the second slot 155 have different configurations to reduce torque ripple.

The first pole 130, the second pole 135, and/or the third pole 140 may be a permanent magnet or may be magnetized when provided with, e.g., DC energy from the power source 105 as illustrated in FIG. 1. Although not shown, field windings may be disposed on one or more of the first pole 130, the second pole 135, and/or the third pole 140 so that DC energy through the field windings may generate a magnetic flux. The magnetic flux of each pole may be associated with the amount of DC energy provided to the field windings. Only three poles are illustrated for purposes of clarity, and as such, the rotor 125 may further include other poles than those illustrated.

The core 145 may include any device configured to support the first pole 130, the second pole 135, the third pole 140, and any other poles used with the rotor 125. In one possible approach, the core 145 may be formed from a metal such as iron. The first pole 130, the second pole 135, and/or the third pole 140 may be integrally formed with the core 145 during, e.g., a manufacturing process.

The first slot 150 and the second slot 155 may be defined by the space between any two of the poles in the rotor 125. As illustrated, the first pole 130 and the second pole 135 may define the first slot 150, and the second pole 135 and the third pole 140 may define the second slot 155. Alternatively, the first slot 150 and the second slot 155 need not be defined by a common pole (e.g., the second pole 135 in FIG. 2). For instance, the second slot 155 may be defined by other poles such as the third pole 140 and a fourth pole 200 (see FIG. 4).

The poles that define the first slot 150 (e.g., the first pole 130 and the second pole 135 of FIG. 2) may define a first opening 160 about a periphery of the rotor 125. The first opening 160 has a first width 165. The poles that define the second slot 155 (e.g., the second pole 135 and the third pole 140 of FIG. 2) may define a second opening 170 about the periphery of the rotor 125 that has a second width 175. One possible asymmetrical configuration of the first slot 150 relative to the second slot 155 may be that the first width 165 is different than the second width 175.

Another possible asymmetrical configuration illustrated in FIG. 2 is that the first opening 160, the second opening 170, or both, may be offset relative the center of the first slot 150 and the second slot 155, respectively. In one example approach, a first axis 180 may bisect the first slot 150, and the first opening 160 may be offset relative to the first axis 180. That is, the first axis 180 may not bisect the first opening 160. In addition or alternatively, a second axis 185 may bisect the second slot 155, and the second opening 170 may be offset or aligned (e.g., the second axis 185 bisects the second opening 170) with the second axis 185. If both the first opening 160 and the second opening 170 are offset with the first axis 180 and the second axis 185, respectively, the first axis 180 may be closer to or farther from bisecting the first opening 160 than the second axis 185 is to the second opening 170.

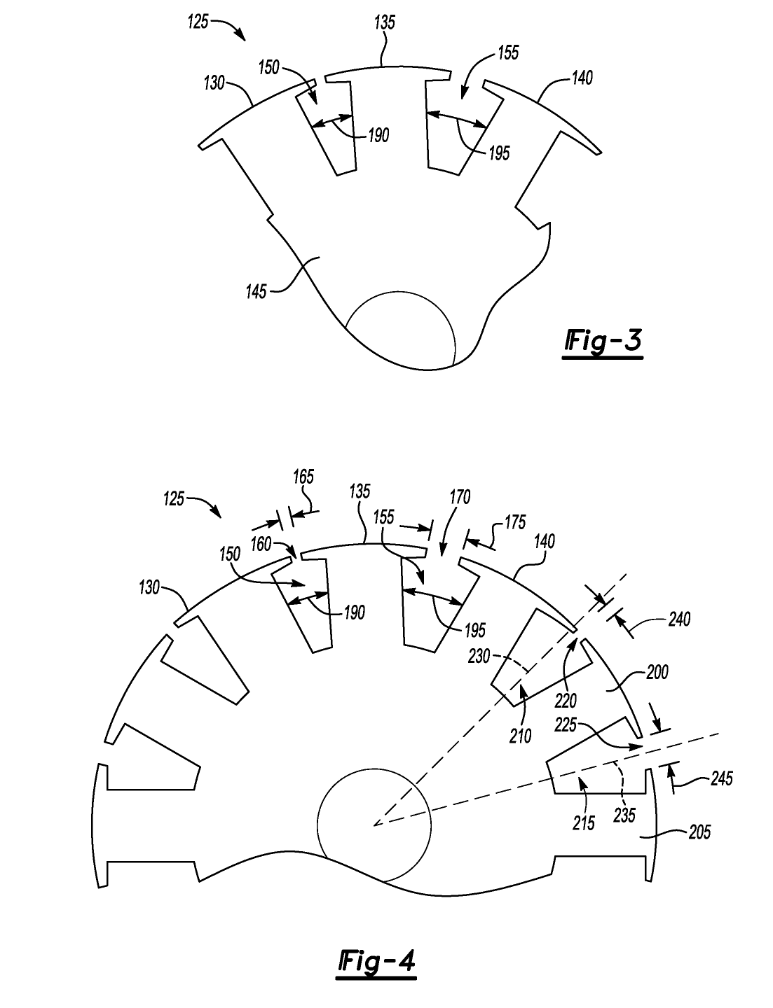

FIG. 3 illustrates other possible asymmetries between the first opening 160 and the second opening 170. For instance, as illustrated in FIG. 3, the space that makes up the first slot 150 has a different area from a side or cross-sectional view than the space that makes up the second slot 155. The space that makes up the first slot 150 may also or alternatively have a different volume than the space that makes up the second slot 155 to reduce the torque ripple.

As discussed above, the first pole 130, the second pole 135, and the third pole 140 may extend radially from the core 145 of the rotor 125. As such, the first pole 130 and the second pole 135 may define the first slot 150 to taper at a first pitch 190 and the second pole 135 and the third pole 140 may define the second slot 155 to taper at a second pitch 195 to reduce torque ripple. One possible asymmetrical configuration that may reduce torque ripple is that the first pitch 190 and the second pitch 195 may be different. For instance, the first pitch 190 may be based on a distance between the first pole 130 and the second pole 135 while the second pitch 195 may be based on a different distance between the second pole 135 and the third pole 140.

FIG. 4 illustrates part of an example rotor 125 having each of the asymmetrical features of FIGS. 2 and 3. The rotor 125 as illustrated includes the first pole 130, the second pole 135, the third pole 140, a fourth pole 200, and a fifth pole 205. The first pole 130 and the second pole 135 define the first slot 150, the second pole 135 and the third pole 140 define the second slot 155, the third pole 140 and the fourth pole 200 define a third slot 210, and the fourth pole 200 and the fifth pole 205 define a fourth slot 215.

The first slot 150 and the second slot 155 of FIG. 4 are similar to the first slot 150 and the second slot 155 of FIG. 3, discussed above. That is, the first slot 150 and the second slot 155 of both FIGS. 3 and 4 have different sizes (e.g., area and/or volume) as well as different pitches. For example, a distance between the first pole 130 and the second pole 135 defines the first slot 150 to taper at the first pitch 190 while a distance between the second pole 135 and the third pole 140 define the second slot 155 to taper at a second pitch 195.

The third slot 210 and the fourth slot 215 may be similar to the first slot 150 and the second slot 155 of FIG. 2, discussed above. For instance, the third slot 210 and the fourth slot 215 may both include openings (e.g., a third opening 220 and a fourth opening 225) defined about the periphery of the rotor 125. The third opening 220 may be offset relative to a third axis 230 that bisects the third slot 210 and the fourth slot 215, while a fourth axis 235 may bisect the fourth opening 225 so that the fourth opening 225 is aligned with the fourth axis 235. Moreover, the third opening 220 may have a third width 240 that is different from a fourth width 245 of the fourth opening 225.

As illustrated in FIGS. 2-4, the asymmetrical slots share a common pole. That is, the first slot 150 and the second slot 155 are both defined, in part, by the second pole 135 while the third slot 210 and the fourth slot 215 are both partially defined by the fourth pole 200. The asymmetrical slots in the rotor 125, however, need not share a common pole. In one possible approach, the first slot 150 may be defined by the first pole 130 and the second pole 135 while the second slot 155 may be defined by either the third pole 140 and the fourth pole 200 or the fourth pole 200 and the fifth pole 205.

Additionally, each slot may only include one asymmetry relative to another slot. The slots of FIGS. 2-4 each have two asymmetrical features relative to another slot. For example, the first slot 150 and the second slot 155 of FIG. 4 have a different pitch and a different size. However, in one possible implementation, the first slot 150 and the second slot 155 may only have one of these asymmetries. Similarly, the third slot 210 and the fourth slot 215 may have only one asymmetry so that, e.g., the third opening 220 and the fourth opening 225 may have the same width or may be offset or aligned with their respective axes by the same amount.

Furthermore, any slot may include any combination of asymmetrical features relative to any other slot to reduce torque ripple. For example, in addition to or instead of having a different size and/or a different pitch, the first slot 150 and the second slot 155 of FIG. 4 may have offset openings and/or different widths of the openings. Indeed, as illustrated in FIG. 4, the first width 165 of the first opening 160 is different than the second width 175 of the second opening 170. Likewise, the third slot 210 and the fourth slot 215 may have different sizes and/or pitches relative to one another in addition to or instead of having offset openings and/or different widths of the openings.

Moreover, groups of slots may establish a pattern that may be repeated by other groups of slots. For instance, in the context of FIG. 4, the asymmetries between the first slot 150, the second slot 155, the third slot 210, and the fourth slot 215 may establish a pattern of asymmetries that may be repeated by another group of slots. That is, a fifth slot may have the same configuration as the first slot 150, a sixth slot may have the same configuration as the second slot 155, a seventh slot may have the same configuration as the third slot 210, and an eighth slot may have the same configuration as the fourth slot 215. This way, another group of slots (e.g., the fifth slot, the sixth slot, the seventh slot, and the eighth) slot may repeat the pattern established by the first group of slots.

While the best modes for carrying out the invention have been described in detail, those familiar with the art to which this invention relates will recognize various alternative designs and embodiments for practicing the invention within the scope of the appended claims.

1. An electric motor comprising:
a stator configured to receive electrical energy and generate an electromagnetic field in accordance with the electrical energy received; and
a rotor in electromagnetic communication with the stator and configured to rotate in accordance with the electromagnetic field generated by the stator, wherein the rotor includes a plurality of poles including a first set of poles and a second set of poles;
wherein the first set of poles defines a first slot and the second set of poles defines a second slot that has a different configuration than the first slot to reduce a torque ripple effect.

2. An electric motor as set forth in claim 1, wherein the first slot has a different area or volume than the second slot.

3. An electric motor as set forth in claim 1, wherein the first set of poles defines a first opening about a periphery of the rotor and has a first width and the second set of poles defines a second opening about the periphery of the rotor and has a second width that is different than the first width.

4. An electric motor as set forth in claim 3, wherein the first opening is offset relative to a first axis that bisects the first slot.

5. An electric motor as set forth in claim 4, wherein the second opening is offset relative to a second axis that bisects the second slot.

6. An electric motor as set forth in claim 1, wherein the rotor includes a core and wherein each of the poles in the first set of poles and the second set of poles extend radially from the core.

7. An electric motor as set forth in claim 6, wherein the first set of poles defines the first slot to taper at a first pitch and wherein the second set of poles defines the second slot to taper at a second pitch that is different than the first pitch.

8. An electric motor as set forth in claim 7, wherein the first pitch is based on a distance between two poles in the first set of poles and the second pitch is based on a distance between two poles in the second set of poles.

9. An electric motor as set forth in claim 1, wherein the plurality of poles includes a first pole, a second pole, and a third pole.

10. An electric motor as set forth in claim 9, wherein the first set of poles includes the first pole and the second pole and the second set of poles includes the second pole and the third pole.

11. An electric motor as set forth in claim 10, wherein the plurality of poles includes a fourth pole, and the first set of poles includes the first pole and the second pole and the second set of poles includes the third pole and the fourth pole.

12. An electric motor as set forth in claim 1, wherein the plurality of poles defines a first group of slots and a second group of slots, wherein the first group of slots includes the first slot and the second slot and establishes a pattern of asymmetries.

13. An electric motor as set forth in claim 12, wherein the second group of slots repeats the pattern established by the first group of slots.

14. A system comprising:
a power source configured to generate direct current energy;
an inverter in electrical communication with the power source and configured to convert the direct current energy into alternating current energy; and
an electric motor having a stator in electrical communication with the inverter and a rotor in electrical communication with the power source and in electromagnetic communication with the stator;
wherein the stator is configured to receive the alternating current energy from the inverter and generate an electromagnetic field in accordance with the alternating current energy received;
wherein the rotor is configured to receive the direct current energy from the power source and rotate in accordance with the electromagnetic field generated by the stator; and
wherein the rotor defines a first slot and a second slot that has a different configuration than the first slot to reduce a torque ripple effect.

15. A system as set forth in claim 14, wherein the first slot has a different area or volume than the second slot.

16. A system as set forth in claim 14, wherein the rotor defines a first opening adjacent to the first slot and a second opening adjacent to the second slot, and wherein the first opening is offset relative to a first axis that bisects the first slot.

17. A system as set forth in claim 16, wherein the second opening is aligned with a second axis that bisects the second slot.

18. A system as set forth in claim 14, wherein the first slot is tapered at a first pitch and the second slot is tapered at a second pitch that is different than the first pitch.

19. A system as set forth in claim 14, wherein the rotor includes a core and a plurality of poles that extend radially from the core.

20. A rotor for an electric motor, the rotor comprising:
a core; and
a plurality of poles extending radially from the core;
wherein the plurality of poles includes a first set of poles defining a first slot and a second set of poles defining a second slot that has a different configuration than the first slot to reduce a torque ripple.
